(19) United States
(12) Patent Application Publication
(10) Pub. No.: US 2016/0368772 A1
(43) Pub. Date: Dec. 22, 2016

(54) Efficient NanoMaterials manufacturing process and equipment

(71) Applicants: Yu-Chen Chen, Hyattsville, MD (US); Guoming Zhong, Bellaire, TX (US)

(72) Inventors: Yu-Chen Chen, Hyattsville, MD (US); Guoming Zhong, Bellaire, TX (US)

(21) Appl. No.: 15/161,163

(22) Filed: May 20, 2016

Related U.S. Application Data
(60) Provisional application No. 62/164,067, filed on May 20, 2015.
(60) Provisional application No. 62/188,818, filed on Jul. 6, 2015.
(60) Provisional application No. 62/244,699, filed on Oct. 21, 2015.

(51) Int. Cl. C01B 31/04; C01G 39/06; C01B 25/00; C01B 21/064

(52) U.S. Cl. CPC C01B 31/0484; C01B 31/043; C01B 21/0648; C01G 39/06; C01B 25/003; B82Y 40/00

(57) ABSTRACT

An efficient method has been invented to make or manufacture holey (or porous) nanomaterials such as 2D graphene by using microwave or similar efficient energy like infrared or halogen oven. The graphene can be put in microwave oven, as example but not limited to, without any catalysts or solvents used during the processes.

### BACKGROUND OF THE INVENTION

Materials, particularly nanomaterials and 2D nano materials, like graphene, boron nitride (BN), and molybdenum disulfide (MoS₂), possess a lot of unique properties such as high surface area, high electrical and thermal conductivity, and excellent mechanic and other properties. However, stacked 2D materials or bulk can have certain undesirable effects like large volume, tortuosity and/or reduced the ion or molecule transport. This can be particularly important for many applications such as energy storage, solar, electronics, OLED, printing, defense and protection materials, air or water separations or purification etc. Recently, 2D holey nanomaterials, with nanoscale holes on its basal plane, was reported to decrease the tortuosity and improve performance used as supercapacitor electrodes.^{1,2} Unfortunately many methods used so far like hydrothermal³ and heat treatments^{1,4} require long times and high energy consumptions. A novel process has been invented here, and it can dramatically decrease time, energy and/or costs etc. We also found that porous or holey materials can reduce volume and increase mechanical strength and many other new properties.

### BRIEF SUMMARY OF THE INVENTION

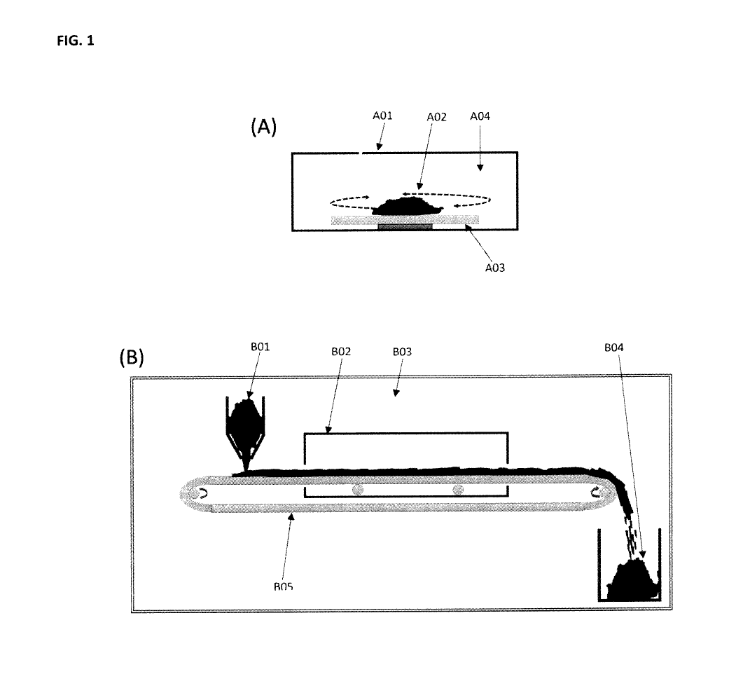

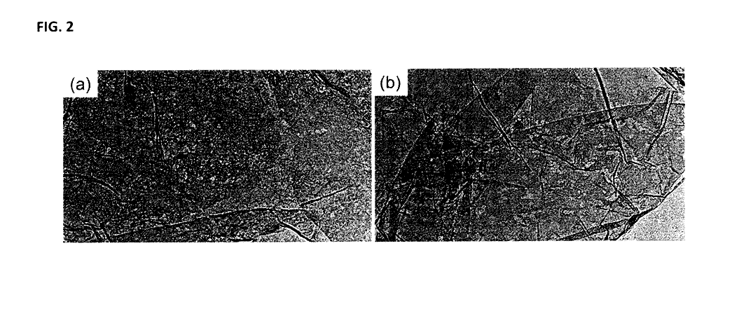

a) Purpose: we have developed scalable, efficient processes for materials, particularly 2D holey nanomaterials, using microwave energy, or similar efficient energy like infrared or halogen energy. These methods can dramatically reduce the process time, energy and costs and create many desirable effects.
b) Brief summary of the processes: These processes to efficiently manufacture, for example 2D holey nanomaterials can be intermittent mode or continuous like roll-to-roll or other modes. The regular graphene is used as starting material or precursor. Catalysts or other chemicals can be added for specific effects. The efficient heating source like microwave or infrared or halogen energy, is applied. The materials are heated in the air in our experiments, but can be inert gas or vacuum or other environments for improvements or certain effects. By controlling source power, time, or added materials or processes certain hole sizes, density, position and area can be achieved. In one example, tire defect carbon in graphene can be selectively removed by heating and reactions with the air to form holes on 2D nanomaterials basal plane.
c) Figures: Our invention and example processes for our holey graphene are shown in FIGS. 1 and 2.
d) Description of the Figures: FIG. 1 Schematics of devices and process to manufacture 2D holey nanomaterials in an intermittent (FIG. 1a) and roll-to-roll (FIG. 1b) mode using microwave heating equipment in the air or inert gas environments. FIG. 2 shows the transmission electron microscopy (TEM) images (same scale) for the as-synthesized holey graphene using domestic microwave oven in an intermittent mode. The action time is short time (a few seconds, FIG. 2a) and long time (minutes FIG. 2b).
e) Applications: The principle and method can be applied to manufacture any holey or porous materials such as graphene, BN, MoS₂, and others. 2D porous or holey nanomaterials can be used in any applications of regular 2D nanomaterials, to replace or be added to achieve certain effects, enhance or create new properties or applications. Some examples are to improve ion or molecule transports, reduce tortuosity or volume, improve mechanical strength, create efficient process, and even new functions, e.g. separation and purification of the water (waste water, oiled water, etc.) and other solvents and gases.
f) Novel Features and advantages: The microwave energy, regular heating or halogen energy methods to manufacture 2D holey nanomaterials has many novel features and advantages, for example,
   Possible catalysts or solvents free processes;
   No influence on the quality of 2D nanomaterials
   Produce better materials by removing defective parts;
   Dry process;
   Environment friendly or green process;
   Energy, time or cost saving (high-efficient power source equipment vs. conventional oven). Production time can be reduced dramatically from >10 hours with conventional oven to a few hours or minutes or seconds in the new heating equipment)
   Roll-to-roll processes, or any forms of continuous manufacturing processes
   Easy operations
   Adding other function groups on grapheme or similar nanomaterials to form desirable properties for separations, detection or protection etc.
   Better or new materials or processes

### POTENTIAL MARKETS

The applications of holey graphene can find many potential markets, such as energy storage, solar, electronics, medical device, Li/Na ion batteries, supercapacitor, sensors, detection, anti-corrosion paint additive or dye, water purification, gas separation, transparent conductive electrodes, touch-screen, thermal compounds, and 3D printing inks, OLED, defense or protection materials, etc.

FIGURES

### REFERENCE

1 Han, X. et al. Scalable Holey Graphene Synthesis and Dense Electrode Fabrication toward High-Performance Ultracapacitors. ACS Nano 8, 8255-8265, doi:10.1021/nn502635y (2014).
2 Lin, Y. et al. Holey Graphene Nanomanufacturing: Structure, Composition, and Electrochemical Properties. Advanced Functional Materials, n/a-n/a, doi:10.1002/adfm.201500321 (2015).
3 Xu, Y. et al. Holey graphene frameworks for highly efficient capacitive energy storage. Nat Commun 5, doi:10.1038/ncomms5554 (2014).
4 Watson; K., Lin;, Y., Ghose;, S. & Connel, J. Bulk preparation of holey graphene via controlled catalytic oxidation. USA patent US20130315816 A1 (2013).

1. a) Materials such as 2D graphene can be manufactured by using more efficient, integrated processes and/or equipment of microwave (or infrared etc) assisted synthesis, blending (or mixng) and/or ultrasound.
b) Porous or holey nanomaterials such as holey graphene can be manufactured by using more efficient, integrated processes and/or equipment of microwave (or infrared etc) assisted synthesis, blending and/or ultrasound.
c) The heating energy, duration, and temperature can vary or be controlled for desirable results.
d) Various components or materials such as catalysts, solvents etc, can be added for specific effects or improvements before, during or after the process;
e) The hole sizes, density, distribution, location, area or defect degrees in the 2D nanomaterials can be controlled by energy power, processing time, temperature, additional materials or processes etc;
f) The energy used for manufacturing can be greatly reduced;
g) The process time can be greatly reduced, even down to seconds in certain cases;
h) The process can be performed in air, inert circumstance, vacuum or special gas or other desirable environments;
i) The process can be intermittent, roll-to-roll mode, or any other continued or continuous processes such as a belt or plate moving or rotating;
j) This efficient process can be used for many materials, including nanomaterials, 2D nanomaterials, graphene, graphene oxide (GO), boron nitride (BN), molybdenum disulfide (MoS₂), black phosphorus, etc;
k) The thickness of materials can vary from a single atom layer, nanometer, sub-micrometer, micrometer, to bulk like several micro meters or more;
l) Compression or compaction or other processes can be applied for many desirable effects such as volume reduction, conductivity, mechanical strength, specific porosity or transports etc;
m) These materials can be used in many applications including but not limited to: solar, coating, printing, painting, dye, additive, batteries electrodes, current collector, energy storage devices, electronic devices, 3D printing inks, separation or purification of gas, water, waste treatments or other materials, and lighting, OLED, sensors, detection, medical devices, medicine, defense or construction materials and systems, protection materials and devices, etc.
n) Such efficient heating can also be assisted or complemented by regular heating sources (such as gas or electrical heating via conduction, convection and/or radiation etc) in certain cases to enhance efficiency.
o) Obtained materials can have improved or new properties, for example, ease or possibility of adding function groups for desirable properties.
p) Obtained materials can be used in many applications or processes to achieve desirable properties. One example is to replace metal properties as shielding or protection. The shielding or protection can be mechanical or electrical, electronic or other forms. One particular example is Electromagnetic compatibility (EMC) and/or Electromagnetic Immunity (EMI)
